(19) United States
(12) Patent Application Publication
(10) Pub. No.: US 2013/0062386 A1
(43) Pub. Date: Mar. 14, 2013

(54) LITTER MOUNTING AND QUICK-ASSEMBLY KIT FOR ALL-TERRAIN VEHICLES AND TRUCK BEDS

(71) Applicants: Chris B. Harris, Amity, OR (US); Terry Lee Wilmeth, (US)

(72) Inventors: Chris B. Harris, Amity, OR (US); Terry Lee Wilmeth, (US)

(21) Appl. No.: 13/607,687

(22) Filed: Sep. 8, 2012

Related U.S. Application Data
(60) Provisional application No. 61/532,632, filed on Sep. 9, 2011.

(51) Int. Cl. B60R 11/00

(52) U.S. Cl. 224/546

(57) ABSTRACT

A medical litter mounting and carrier quick-assembly kit for flatbeds of trucks and all-terrain vehicles is described. The quick assembly kit comprises track rails upon which catch brackets are slideably engaged adjust to the width of any litter or stretcher having stirrups. The catch brackets engage and secure the litter stirrups for mounting of the litter on the flatbed of the vehicle.

### CROSS REFERENCE

This application claims benefit of U.S. Provisional Application No. 61/532,632 filed on Sep. 9, 2011.

### FIELD OF INVENTION

This invention relates to quick-assemble patient litter- or stretcher-carrying mounts for trucks, trailers and all-terrain vehicles for both military and civilian applications involved in evacuation of casualties.

### BACKGROUND

The art is replete with examples of medical evacuation systems for field use in military and civilian applications. Many examples are directed to airlift situations, where systems are devised for transporting patients in stretchers or NATO-style litters in helicopters or fixed-wing aircraft. These examples include the following patent citations:

U.S. Pat. No. 4,178,032 to Hone, which discloses a litter carrying apparatus for use in air ambulances or helicopters; U.S. Pat. No. 4,397,432 to Resetar, wherein an adjustable litter support assembly for aircraft is disclosed, using stanchions fittings with litter support arms that can be moved up or down to accommodate patients on litters. U.S. Pat. No. 4,783,025 to Moffett, which discloses movable pallet for movably supporting a patient in an emergency medical setup in a helicopter. U.S. Pat. No. 5,383,629 to Morgan discloses a multi-tiered litter rack system designed for disposition on walls in a helicopter or a fixed wing aircraft; U.S. Pat. No. 5,738,306 to Moss et al., disclosing a tiltable litter receiving table loading and transporting patients in helicopters and fixed wing aircraft, while at the same time providing a table for emergency patient care.

For ground and/or air vehicles, examples of litter mounting and carrying apparatuses are disclosed in the following citations:

U.S. Pat. No. 6,923,606 to Fehrle et al., disclosing a reconfigurable patient support pallet system for transporting patients on NATO-style litters and/or airline-style or other seats, in response to the problems of existing patient evacuation systems, and to meet the need for a patient evacuation system for use in a variety of modes of transportation. The pallet system includes a pallet mounted to the floor of a vehicle. The pallet comprises a plurality of track rails and attachment points for attaching a litter stanchion set, and/or attaching seats to the pallet. U.S. Pat. No. 7,328,926 to Myers et al., disclosing a litter support system adapted for attachment to the chassis of a vehicle with a cargo bed, such as found in an ambulance. The apparatus is designed to receive and lock NATO-style litters on a rack system, and allow lateral movement of the secured litter from the wall of the cargo area towards the middle of the cargo area to facilitate loading of the litters onto the racks, and emergency patient care enroute by an attendant; U.S. Pat. No. 7,883,133 to Chinn, disclosing a wall-attachable litter rack system holding upper and lower litter supports for vehicles for loading and transporting NATO-style litters, where litter supports are rotatable for storage and deployment, and horizontally movable for patient treatment.

In military operations, tactical vehicles such as the light tactical all-terrain vehicle (LTATV) are equipped for rapid deployment of soldiers and weapons over any type of terrain. However, LTATVs can also be used for evacuation of casualties on the battlefield. To this end, they must be outfitted with low-profile and/or quick-mount medical litter racks or mounting rails that provide the capability to secure and carry one or more litters. At the same time the litter mounting apparatus should not interfere with normal operations of the host vehicle when not in use. Currently, there are examples of litter carrying racks that are available to fit ATVs, however, these are not convenient to install, and carry the litter with its axis perpendicular to the direction of travel.

Similar considerations apply to civilian patient evacuation applications, such as for search and rescue operations, or for disaster victim evacuation operations performed by emergency workers using makeshift emergency vehicles. ATVs are frequently used in such operations, and transportation of litters out of a wilderness area using an ATV requires use of unsatisfactory litter racks that produce the same conditions as described above.

### SUMMARY

To this end, improvement in the current attributes related to patient evacuation have been developed by the instant inventors, resulting in a highly practical and efficient design of a quick-assemble litter carrier kit, or litter kit as it will be referred to henceforth. The preferred embodiment of the invention is designed to be mounted on the flatbed of a truck or of an all-terrain vehicle so equipped. Furthermore, it comprises two or more track rails, and at least two U-shaped litter-stirrup catch brackets (for litters equipped with stirrups, such as NATO-style litters) slideably engaged on each track rail. The track rails comprise a dovetailed groove and a plurality of through- holes that extend through the width of the rail and are evenly spaced apart. These through-holes are intended to accept the shaft of a locking pin, pop pin or a plunger pin in order to fix the position of the litter catch bracket. The litter catch brackets slide freely on the track rail, and can be positioned to accommodate any width of stretcher or litter equipped with stirrups. Litter catch brackets are locked in position by use of locking pins, pop pins or plunger pins and the like, by first aligning one or both insertion holes machined into the two vertical rail guides of the catch bracket and one of a plurality of through-holes machined in the body of the track rail, then inserting the pin into the aligned holes.

Once positioned, the U-shaped litter catch brackets of the preferred embodiment of the invention can engage the stirrups of a NATO-style litter for mounting and securing the litter. To mount a litter on the mounting assembly, the litter stirrups are simply placed over the catch brackets. The four litter stirrups are lowered to engage the catch brackets, whereby the stirrup is placed between the two uprights of each U-shaped catch bracket. The catch bracket has sufficient width to accommodate a litter stirrup, whereby the stirrup is secured by inserting a bolt, locking pin and the like through the two upright portions of the U-shaped brackets via one of a plurality of perforations machined into both panels.

### BRIEF DESCRIPTION OF THE DRAWINGS

FIG. 1a Individual components of the litter kit in exploded view.

FIG. 1b Assembled Individual components of the litter kit.

FIG. 2 View showing details of catch bracket engaged on track rail.

FIG. 3 View showing details of catch bracket engaging a mounted NATO-style litter stirrup.

### DETAILED DESCRIPTION

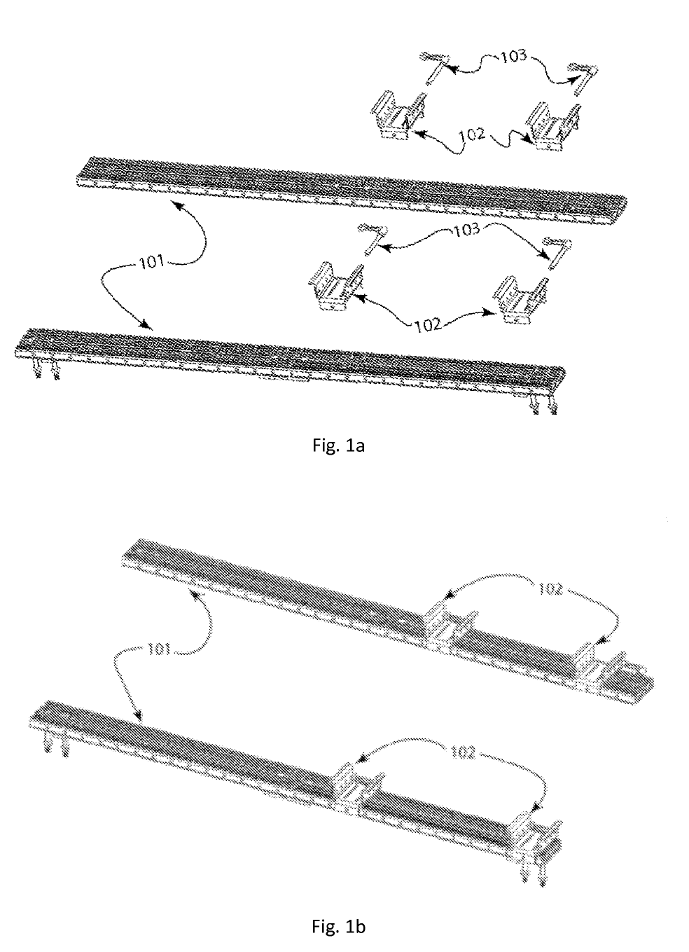

Referring to FIG. 1a, the individual components of the preferred embodiment of the litter mount assembly kit 100 are visualized in an exploded view, showing two track rails 101, two catch brackets 102 for each rail 101, and locking pins 103, one for each bracket. The assembled view is shown in FIG. 1b, with catch brackets 102 engaged on the surface of track rails 101 with locking pins engaged. The track rails can furthermore be bolted to a flatbed of a truck or all-terrain vehicle (ATV) so equipped with a flatbed, or to the frame of an ATV.

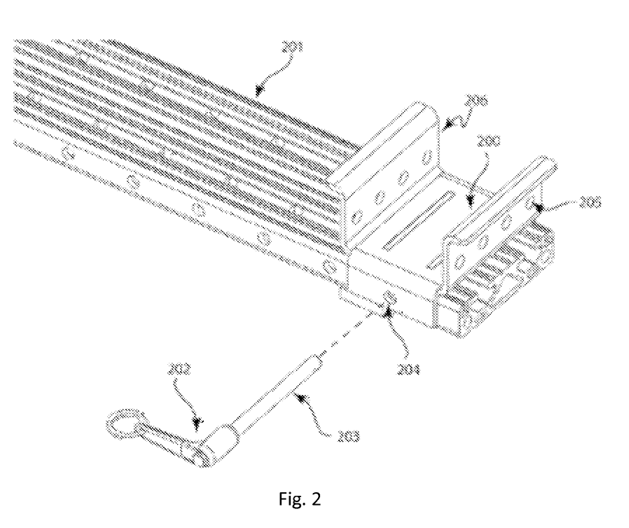

FIG. 2 shows a view of the preferred embodiment of litter kit assembly catch bracket 200 in greater detail. The U-shaped bracket 200 slideably engages along the top surface of track rail 201, although a dovetailed groove is shown in cross section can be used as a slideable engagement surface as well. Bracket 200 is fixed in a desired position by engagement of locking pin 202, whereby shaft 203 of pin 202 is inserted through one of a plurality of holes 204 that pass transversely through the body of track rail 201. A second plurality of holes 205 are perforated through vertical segments 206 of catch bracket 200 provided for passing a bolt or other fastening means through to secure the stirrups of a litter.

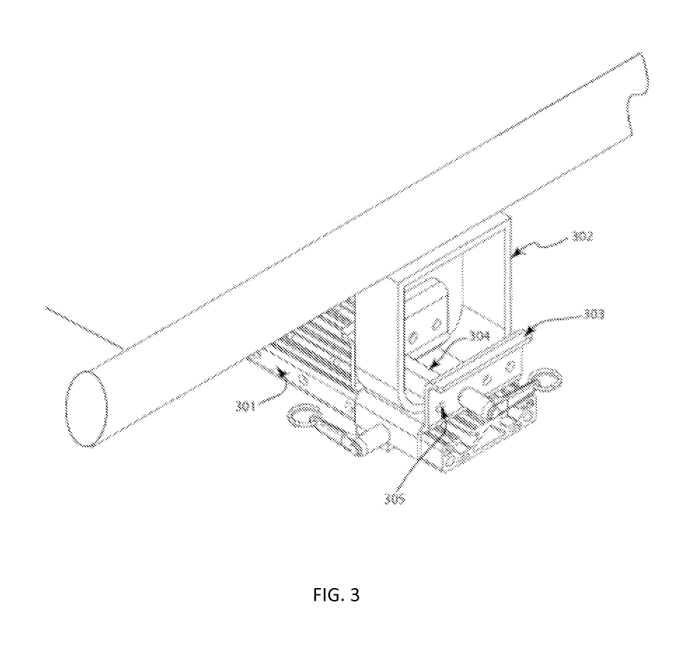

FIG. 3 shows the preferred embodiment of litter kit assembly detail of catch bracket 300 slideably engaged along the top surface of track rail 301, and simultaneously securing a NATO-style litter by engaging stirrup 302 of the litter between vertical segments 303. To secure the litter from sliding forward or backward, locking pin 304 is inserted through one of a plurality of holes 305 perforated through both vertical segments 303. A locking pin is shown for the sake of illustration, however any other type of pop pin, plunger pin or bolt can be substituted.

The embodiment described herein is meant to be exemplary, and not intended to limit the scope and spirit of this invention. Those skilled in the art will recognize that equivalent structures fall within the scope of this invention. NATO-style litters are chosen as the exemplary litter possessing stirrups, but the invention is intended for other similar litters as well.

1. A litter carrying system, comprising:
At least two track rails;
At least one catch bracket mounted on each rail; and
At least one locking pin disposed on each catch bracket for locking onto the track rails.
